(19) United States
(12) Patent Application Publication
(10) Pub. No.: US 2021/0336303 A1
(43) Pub. Date: Oct. 28, 2021

(54) PHASE CHANGE MATERIALS FOR THERMAL PROTECTION IN BATTERIES

(71) Applicant: Toyota Research Institute, Inc., Los Altos, CA (US)

(72) Inventors: Muratahan Aykol, San Jose, CA (US); Abraham S. Anapolsky, San Mateo, CA (US)

(21) Appl. No.: 16/860,561

(22) Filed: Apr. 28, 2020

(51) Int. Cl. H01M 10/659; C09K 5/14; C09K 5/06

(52) U.S. Cl. CPC H01M 10/659; C09K 5/06; C09K 5/14

(57) ABSTRACT

A battery protection system that attenuates the impact of a thermal event above 100° C. in the environment of a battery includes at least one inorganic phase change material (IPCM). The IPCM undergoes a solid-solid or solid-liquid phase change at temperatures in excess of 100° C. and with a heat absorption of at least 50 kJ/kg. The IPCM is an anhydrous inorganic salt or compound that absorbs heat by a phase change from one solid phase to a second solid phase or to a liquid phase. A battery-package is formed that includes the battery protection system on or within the battery-can. The battery-package can have the IPCM within a composite, and the composite can include a thermally conductive filler. The battery protection system can have a series of heat absorbing IPCMs that absorb heat at a series of ascending temperatures.

### TECHNICAL FIELD

The present disclosure generally relates to materials for thermal protection of batteries and, more particularly, to materials that undergo a phase change at a temperature region that allows the absorption of heat during an incident where an excess of heat is generated in the battery.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor impliedly admitted as prior art against the present technology.

The automobile industry has increasingly enabled the powering of vehicles using electricity from electrochemical cells, or batteries, over the past decades. The control of temperatures in these batteries is important for optimization of the power generating capacity and extended battery life. Temperature control and thermal protection of batteries is often carried out using air cooling, liquid cooling, phase change materials (PCMs) or combinations of these systems that is thermally coupled to the battery to maintain a desired temperature range for normal operation. The typical phase change material is one that undergoes melting and freezing with the accompanying absorption and release of thermal energy or undergoes other phase transitions that are accompanied by heat release or absorption. Typical materials that have been used are waxes, eutectic alloys, salts, eutectic salts, and salt hydrates, where generally the goal is to maintain the temperature, for example, between about 0 and about 50° C.

Thermal management can be directed to protection from potentially catastrophic, high-temperature thermal events. For example, lithium ion batteries are prone to a thermal runaway that starts, typically, close to 100° C., accelerates towards 200° C., and can result in an irreversible runaway accompanied by a substantial heat release leading to a major safety issue. To this end, the use of contained phase change materials that are functional at elevated temperatures for absorption of excessive heat from dangerous thermal events is desirable.

### SUMMARY

This section provides a general summary of the disclosure and is not a comprehensive disclosure of its full scope or all its features.

In various aspects, the present teachings provide a battery protection system that includes one or more inorganic phase change materials (IPCMs) that deliver high heat absorption during phase changes that occur at temperatures in excess of 100° C. and with the absorption of at least 50 kJ/kg. The IPCM can remain in solid state during the phase change and/or can undergo a solid-liquid transformation during the thermal event. The battery protection system includes the IPCM within the immediate environment of the battery.

In other aspects, the present teachings provide for a battery-package that includes a battery protection system having at least one IPCM. The IPCM is used in a powder or granular form, with or without inclusion of a binder, or combined into a composite. The IPCM can be coated, pasted, painted, encapsulated in a container shell and adhered or otherwise included within the battery-package as a protective coating or combined within the battery separator.

In still further aspects, the present teachings provide a method to attenuate the impact of a battery thermal event on the battery and its environment, where an IPCM is situated to absorb heat during the event at temperatures in excess of 100° C. The IPCM can remain in solid state during the phase change and/or can undergo a solid-liquid transformation during the thermal event.

Further areas of applicability and various methods of enhancing the above coupling technology will become apparent from the description provided herein. The description and specific examples in this summary are intended for purposes of illustration only and are not intended to limit the scope of the present disclosure.

### BRIEF DESCRIPTION OF THE DRAWING

The present teachings will become more fully understood from the detailed description and the accompanying drawing, wherein:

FIG. 1 shows a schematic drawing of a battery-package having IPCMs included on the inside and outside of the battery-can and as a filler within the separator.

FIG. 2 shows a drawing of various shapes for the battery-can format.

FIG. 3 shows a drawing of an interface between a battery-can and an IPCM included on an interior surface of the battery can.

FIG. 4 shows a battery-package that includes multiple battery cells that are periodically dispersed in an IPCM material that fills the gap between cells.

It should be noted that the figure set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific embodiments within the scope of this technology.

### DETAILED DESCRIPTION

The present teachings provide a battery protection system that includes one or more inorganic phase change materials (IPCMs). The battery protection system attenuates possible thermal events that may become catastrophic to the environment of the battery, such as an automobile or other electric powered vehicle, an electronic device or a stationary energy storage unit. The IPCMs are selected from those that provide high heat absorption, of at least 50 kJ/kg during their phase changes. The phase change occurs at temperatures in excess of 100° C., and even in excess of 200° C., to attenuate potentially catastrophic heating of a battery. The battery protection system includes the IPCM within the immediate environment of the battery.

The presently disclosed battery protection system functions by absorption of heat by the IPCM. The IPCM can undergo a solid-solid phase change and/or can undergo a solid-liquid transformation during the thermal event. The IPCM is an anhydrous salt or an inorganic compound that transforms at temperatures of at least 100° C. and preferably does not undergo a liquid-gas transformation at temperatures below about 150° C. The IPCM does not present a flammability risk, where it is non-flammable or of low flammability. This is in contrast with most phase change materials (PCMs) employed in common thermal regulation systems for batteries; which consist of organic phase change materials, such as paraffin waxes, whose flash point can be exceeded during an excessive thermal incident, or salt hydrate, where during the thermal incident vaporized water can lead to significant expansion of the PCM's volume that could be deleterious to the battery and its environment's integrity.

As detailed herein, the present teachings not only include the development of the battery protection system, but also the use of the battery protection system within a battery-package. The battery-package includes its physical housing, a battery can, and all components of the battery. The one or more IPCMs can be coated, pasted, painted, encapsulated in a container shell and adhered or otherwise included on either surface of the battery housing, on or within the battery, for example, the IPCM can be combined with the separator between the battery's electrodes or coated on one or both of the electrodes.

The present teachings provide a method for protection of a battery and its environment during a thermal event where significant heat generation occurs. As enabled by the IPCMs, heat generated by the battery is at least partially absorbed by the phase transformation of the IPCM, and at least partially mitigate the impact of the thermal event at temperatures above 100° C. where typical thermal management PCMs are not effective. The phase transformation occurs with a solid-solid transformation, a solid-liquid transformation, or both in a single IPCM or by combination of a plurality of IPCMs. When using one or more IPCMs, the IPCM can be included in one or more sites within the battery-package, where the different sites may have the same or different IPCMs.

In an aspect of the invention, the one or more IPCMs are selected from the salts in Table 1, below, and selected to have high heat absorption per mass and a high temperature for the phase change by which the heat is absorbed.

TABLE 1
IPCMs for inclusion in the battery protection system

| | | Transition | Absorbable |
|---|---|---|---|
| | Transition | Temperature | Heat |
| Salt | Type | (° C.) | (kJ/kg) |
| Ti₃O₅ | solid-solid | 177 | 40-59 |
| KHF₂ | solid-solid | 197 | 142 |
| NbCl₅ | solid-liquid | 206 | 125 |
| SbF₃ | solid-liquid | 291 | 119 |
| KOH | solid-solid | 243 | 114 |
| NaBF₄ | solid-solid | 243 | 61 |
| LiNO₃ | solid-liquid | 254 | 375 |
| KBF₄ | solid-solid | 283 | 110 |
| FeCl₃ | solid-liquid | 307 | 265 |

In aspects of the invention, an IPCM can be used directly, in a powder or granular form or processed into a pellet, sheet, or any other shape before inclusion in a battery-package. The processed shape can be formed with the IPCM and a binder or resin. The IPCM can be a filler in a composite. In addition to the IPCM and continuous matrix, other fillers can be included to enhance heat transfer through the composite, for example, graphite fillers, other carbon forms, or metals can be included to transfer heat rapidly to the IPCM. The continuous matrix can be an epoxy, silicone, or any other resin material. The IPCM can be a filler in a plastic, for example, a polyethylene or polypropylene film that can be used as a separator in the battery coupled with the battery protection system. The IPCM formulation, with the ultimate state being a particle coating or bound within a composite, can be applied to the battery-package as a slurry of the particle in a solvent or the composite can be applied from a liquid or solution state by any coating method, including roll coating, dip coating, or spray coating. The applied coating can be on an internal and/or external surface of the battery-can, on at least one surface of the battery, or otherwise contacting the direct environment of the battery to be protected. Where IPCM formulations have the potential to react with water/moisture, oxidizing agents or other organic or inorganic components of a battery or its environment, IPCM formulation can be encapsulated in a suitable encapsulant or shell selected on the basis of its inertness with the IPCM and battery components. The shell can be a polymer, steel, stainless steel, glass, ceramic or other type of relatively inert materials. The encapsulant can be a composite material, such as a glass or ceramic that is filled with a thermal conductor to retain the desired encapsulation without a severe retardation of the IPCM's ability to rapidly respond to the thermal event for which it is included.

The IPCMs possess the capacity to decompose with the release of toxic or corrosive materials if the attenuation or inhibition of the thermal event is not sufficient to contain the runaway for any reason. The encapsulant of the encapsulated IPCM or an accompanying filler can react with or absorb the released toxin or corrosive. For example, an encapsulant silicate glass can react with released HF or a basic salt can be included to neutralize a released acid. Carbons employed to transfer heat can also function as an absorbent of toxins.

The battery protection system can have a series of heat absorbing IPCMs that absorb heat at a series of ascending temperatures. Multiple IPCMs can be combined to achieve a multi-stage protection capability in a battery protection system. For example, individual domains of NbCl₅, KHF₂ and FeCl₃ can be included in a battery-package to provide 3-stage protection where the three different materials provide phase transitions for heat absorption that initiate at three separate temperatures, 197, 206, and 307° C. The proportions of the different IPCMs can vary as desired to provide any anticipated profile of thermal events.

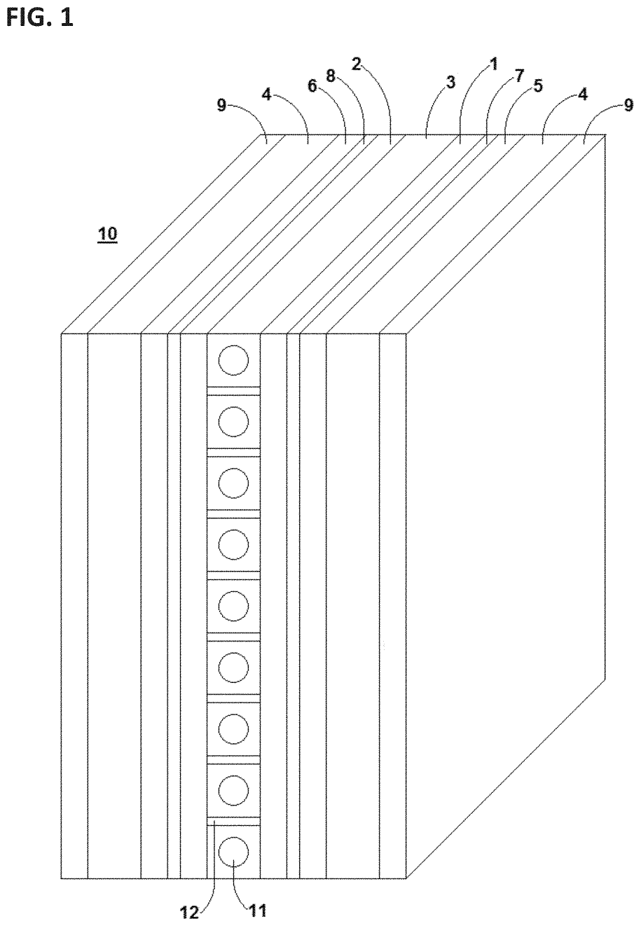

FIG. 1 is a drawing of a battery-package 10 where the anode 1 and cathode 2 of the battery are separated by a separator 3 and contained within a battery-can 4. In various aspects, the battery-package includes IPCMs as sheets 5 and 6 on the inside of the battery-can 4 where the anode 1 and cathode 2 are separated from the IPCM sheets 5 and 6 by barrier layers 7 and 8, respectively. As shown, the exterior of the battery-can 4 is covered with a layer of IPCM 9. As shown, the separator 3 includes isolated domains 11 of IPCMs in addition to the channels 12 for electrolyte that percolate between the anode 1 and cathode 2 of the battery. The composition of the IPCM of sheet 5 can differ from that of sheet 6; and both can be different from that of layer 9. Each of multiple domains 11 can be occupied by a single IPCM and different domains 11 can be occupied by the same IPCM or by different IPCMs. These domains 11 can be the same IPCM or a different IPCM than those of the sheets 5 and 6 or the external layer 9. In a typical polyolefin separator 3, the polyolefin can encapsulate the various IPCM domains 11 and isolate the IPCM(s) from the electrolyte in the channels 12. Although illustrated with single sheets 5 and 6 and a single layer 9, a plurality of parallel sheets and layers can be constructed of various IPCMs that undergo phase transitions at different temperatures. The sheets and layers can be a composite and/or encapsulations of different IPCMs. Dimensions shown for the various components in FIG. 1 are for ease of illustration and are not indicative of their relative dimensions or disposition in a battery-package according to aspects of the invention.

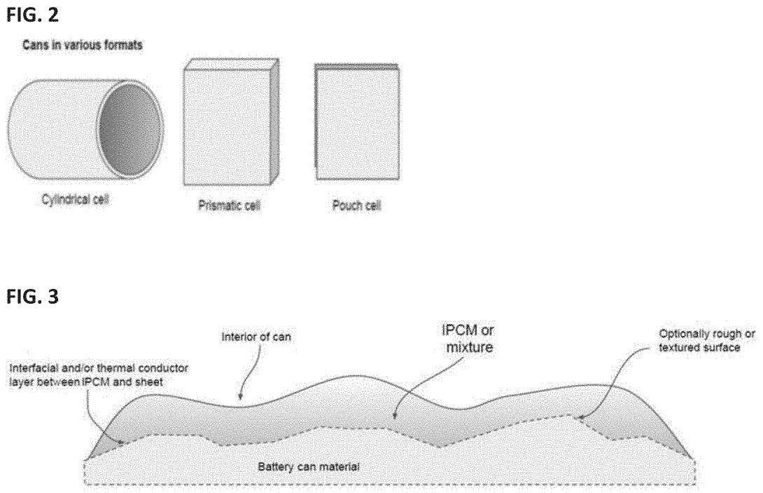

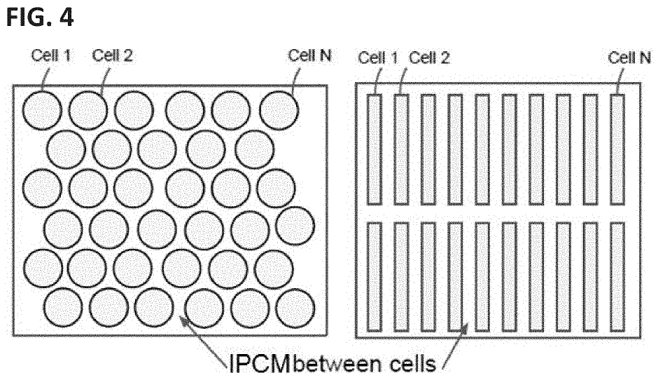

FIG. 2 shows various shapes for the battery cans, such as, cylindrical, prismatic, and pouch cells. The IPCM can be coated on the interior or exterior of the cell, as indicated in FIG. 3 for an interior IPCM coated battery can. The IPCM can may be mixed with a conductor or other components. The interface can include an interfacial layer for protection of the battery and/or can include a thermal conductor layer to promote heat transfer to the IPCM. The IPCM may be included as a continuous material in the interstitial spaces between a matrix of cells in a battery pack or module, as shown in FIG. 4.

The battery-package can include other PCM within a battery protection system for more typical temperature control of batteries using a PCM that is thermally coupled to the battery to maintain a desired temperature range for normal operation. The additional PCM can be one or more of the IPCMs of Table 1, above, included in a eutectic mixture that undergoes a phase change at temperatures below about 200° C., for example, below 150° C., or below 100° C. The eutectic employed can include one or more of the IPCMs of Table 1, above. For example, a eutectic of KOH with K₂SO₄ or with K₂CO₃ or a eutectic of LiNO₃ with NaNO₃ can be included for maintenance of a desired working temperature or provide protection at a lower temperature than the phase-change temperatures of the end-members. The eutectic may be separated from the single component IPCM materials incorporated for the protection from the potentially catastrophic heating of a battery.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of an embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A battery protection system for the attenuation of thermal events in a battery, the battery protection system comprising at least one non-flammable anhydrous inorganic phase change material (IPCM) in thermal contact with the battery or a battery-can housing the battery, wherein the IPCM undergoes a phase change at a temperature of at least 100° C. with an absorption of at least 50 kJ/kg of heat.

2. The battery protection system according to claim 1, wherein the phase change is a solid-solid phase change or a solid-liquid phase change.

3. The battery protection system according to claim 1, wherein the IPCM is selected from the group consisting of: Ti₃O₅, KHF₂, KOH, NaBF₄, KBF₄, NbCl₅, SbF₃, LiNO₃, and FeCl₃.

4. The battery protection system according to claim 1, wherein the at least one non-flammable anhydrous IPCM comprises a plurality of different IPCMs.

5. The battery protection system according to claim 4, wherein the plurality of different IPCMs are isolated IPCMs.

6. The battery protection system according to claim 1, wherein the IPCMs are encapsulated IPCMs, wherein an encapsulant of the encapsulated IPCM comprises at least one of a polymer, steel, stainless steel, glass, and ceramic.

7. A battery-package for containing a battery, the battery-package comprising a battery protection system comprising at least one non-flammable anhydrous inorganic phase change material (IPCM) where the IPCM undergoes a phase change at a temperature of at least 100° C. with an absorption of at least 50 kJ/kg of heat, wherein the battery protection system is on a battery-can, on the battery, or within the battery-can.

8. The battery-package according to claim 7, wherein the phase change is a solid-solid phase change or a solid-liquid phase change.

9. The battery-package according to claim 7, wherein the IPCM is selected from the group consisting of Ti₃O₅, KHF₂, KOH, NaBF₄, KBF₄, NbCl₅, SbF₃, LiNO₃, and FeCl₃.

10. The battery-package according to claim 7, wherein the battery protection system is on or within the separator between the battery's electrodes.

11. The battery-package according to claim 7, wherein the battery-package further comprises a eutectic mixture of inorganic salts, wherein the eutectic mixture comprises at least one of the inorganic salts selected from the group consisting of KHF₂, KOH, NaBF₄, KBF₄, NbCl₅, SbF₃, LiNO₃, and FeCl₃.

12. The battery-package according to claim 7, wherein the at least one IPCM comprises a filler in a composite.

13. The battery-package according to claim 12, wherein the composite further comprises a heat transfer filler.

14. The battery-package according to claim 13, wherein the heat transfer filler comprises carbon or a metal.

15. The battery-package according to claim 7, wherein the IPCM is an encapsulated IPCM, wherein an encapsulant of the encapsulated IPCMs comprises at least one of a polymer, steel, stainless steel, glass, and ceramic.

16. A method of attenuating thermal events near runaway in a battery environment, comprising:
providing a battery-package comprising a battery protection system comprising at least one non-flammable anhydrous inorganic phase change material (IPCM) on a battery-can and/or within the battery-can encasing a battery; and
absorbing heat in the at least one IPCM by at least one phase change at a temperature of at least 100° C. with an absorption of at least 50 kJ/kg of heat.

17. The method according to claim 16, wherein the phase change is a solid-solid phase change or a solid-liquid phase change.

18. The method according to claim 16, wherein the IPCM is selected from the group consisting of Ti₃O₅, KHF₂, KOH, NaBF₄, KBF₄, NaCl₅, SbF₃, LiNO₃, and FeCl₃.

19. The method according to claim 16, further comprising transferring the heat from the battery to the IPCM, wherein the IPCM is in a composite further comprising a heat transfer filler.

20. The method according to claim 16, wherein the IPCM is an encapsulated IPCM, wherein an encapsulant of the encapsulated IPCM comprises at least one of a polymer, steel, stainless steel, glass, and ceramic.
